(19) United States
(12) Patent Application Publication
(10) Pub. No.: US 2003/0089802 A1
(43) Pub. Date: May 15, 2003

(54) Injection device and method for injecting a fluid

(76) Inventors: Bernd Mahr, Plochingen (DE); Martin Kropp, Tamm (DE); Hans-Christoph Magel, Pfullingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,695

(22) PCT Filed: Jan. 11, 2001
(86) PCT No.: PCT/DE01/00080

(30) Foreign Application Priority Data
Jan. 20, 2000 (DE) 100 02 272.3
Feb. 23, 2000 (DE) 100 08 268.8

(51) Int. Cl. F02M 59/00

(52) U.S. Cl. 239/533.2

(57) ABSTRACT

The invention relates to an injection device with an injector (12), a pressure intensifier (16) for intensifying a primary pressure, a valve device (18, 20) for actuating the pressure intensifier (16), and an actuating element (22) for actuating the valve device (18, 20), wherein the valve device has at least one first 2/2-port directional-control valve (18) and one second 2/2-port directional-control valve (20), which can be actuated by the actuating element (22). The invention also relates to a method for injecting fluid, in which an actuating element (22) is activated, the actuating element (22) actuates a valve device (18, 20), the valve device (18, 20) actuates a pressure intensifier (16) for intensifying a primary pressure, and an injector (12) is opened, wherein the actuating element (22) actuates a first 2/2-port directional-control valve (18) and a second 2/2-port directional-control valve (20) of the valve device.

### PRIOR ART

The invention relates to an injection device with an injector, a pressure intensifier for intensifying a primary pressure, a valve device for actuating the pressure intensifier, and an actuating element for actuating the valve device. The invention also relates to a method for injecting fluid, in which an actuating element is activated, the actuating element actuates a valve device, the valve device actuates a pressure intensifier for intensifying a primary pressure, and an injector is opened.

A device and method of this generic type are known, for example, from EP 0 562 046 B1. The basic requirement of such a system is comprised in executing the fuel injection at the greatest possible injection pressure. A high injection pressure exerts positive influences on the function of a motor; for example, pollutant emissions and fuel consumption are reduced. In order to produce a high injection pressure, a pressure intensifier is provided, which by means of a hydraulic transmission, converts a primary pressure, possibly supplied by an accumulator, into the desired high injection pressure. A suitable pressure intensification can be adjusted through the appropriate selection of surfaces that are acted upon by force and the countervailing forces of elastic means.

The pressure intensifier and the injector can be triggered by virtue of the fact that two 2/2-port directional-control valves are provided, which are respectively triggered by two separate actuating elements. A separate set of drive electronics must be provided here for each actuating element. A suitable matching of the drive electronics permits switching sequences to be achieved, which can produce different injection operations. However, the above-described apparatus-based solution is expensive.

A pressure intensification of this generic type is particularly useful in connection with a common rail system. In “common rail” accumulator injection, the primary pressure production and the injection are decoupled from each other. The injection pressure is generated independent of the motor speed and injection quantity and is stored in the “rail” (fuel accumulator), ready for the injection. Fundamentally, this permits a favorable injection sequence to be produced since in particular, the injection pressure and injection quantity can be determined independently of each other for each operating point of the motor. However, the pressure in the common rail is currently limited to approx. 1600 bar; an increase in the pressure would be desirable for reasons relating to emissions and fuel consumption. Currently, pressure intensifiers with a transmission ratio of 1:7 are known. A pressure intensifier in combination with a common rail system could therefore produce particularly favorable results.

### ADVANTAGES OF THE INVENTION

The injection device according to the invention, according to claim 1, is based on the prior art in that the valve device has at least one first 2/2-port directional-control valve and one second 2/2-port directional-control valve, which can be actuated by the actuating element. Since the two 2/2-port directional-control valves can be actuated by the same actuating element, the apparatus expense at this point is reduced in comparison to the use of two separate valve controllers, which achieves an improvement of the system as a whole.

Preferably, the first 2/2-port directional-control valve and the second 2/2-port directional-control valve can be actuated by the actuating element by means of a shared hydraulic coupling chamber. This measure also advantageously offers the possibility of reducing the apparatus expense for the use of two valves. A single coupling chamber is sufficient since the 2/2-port directional-control valves can be suitably matched to each other. For example, through a suitable adjustment of the hydraulic surfaces and elastic means, the valves can react to the actuation by the actuating element at different times and in different activation states (partial stroke/full stroke). The hydraulic coupling chamber can also be used for a force/path transmission and for the compensation of tolerances, e.g. length changes.

Preferably, a common rail supplies the primary pressure. It is consequently possible to combine the advantages of a common rail system with the pressure-intensified injection device. The common rail pressure, which is currently limited to approximately 1600 bar, can be pressure intensified; this reduces emissions and fuel consumption.

It is particularly advantageous if the injection system is stroke-controlled. A control chamber is consequently provided, which when pressure-relieved, permits the injector to open. This makes it possible to open the injector despite the presence of a relatively low pressure in the inlet region of the injector and thus to execute an injection—possibly a preinjection—at a low pressure, for example at the rail pressure.

Preferably, in a first state, the first 2/2-port directional-control valve closes a control chamber for a stroke control and in a second state, the first 2/2-port directional-control valve opens the control chamber for the stroke control. An actuation of the first 2/2-port directional-control valve is therefore sufficient to trigger an injection.

Preferably, in a first state, the second 2/2-port directional-control valve closes a return chamber of the pressure intensifier off from a return system and in a second state, the second 2/2-port directional-control valve couples the return chamber of the pressure intensifier to the return system. The return chamber consequently represents a control chamber for the pressure intensifier. The return chamber of the pressure intensifier is then pressure-relieved by an opening of the second 2/2-port directional-control valve, which leads to a pressure intensification by means of the pressure intensifier. This pressure is supplied to the injector so that an injection can occur at a high pressure. This injection occurs at a higher pressure than the injection based on the actuation of the first 2/2-port directional-control valve. Consequently, the advantages of both injection operations can be combined with each other.

Advantageously, the first 2/2-port directional-control valve and the second 2/2-port directional-control valve are matched to each other so that a partial actuation of the actuating element can initially switch the first 2/2-port directional-control valve from its first state into its second state and then, through further actuation of the actuating element, the second 2/2-port directional-control valve can be switched over from its first state into its second state. Consequently, for example, the stroke control executed by the first 2/2-port directional-control valve can be used for a preinjection at the low rail pressure, while the actuation of the first valve with a subsequent actuation of the second 2/2-port directional-control valve is used for a main injection at an increased pressure. It is consequently possible to provide a separate triggering of the injector (stroke control) and of the pressure buildup by means of the pressure intensifier. This permits a varied shaping of the injection sequence.

Advantageously, a control chamber for the stroke control is connected to the first 2/2-port directional-control valve by means of a first throttle and the control chamber for the stroke control is connected to the inlet region of the injector by means of a second throttle. The opening speed of the nozzle needle in the stroke-controlled injection can be determined by means of the through flow difference between these two throttles.

Preferably, a working pressure chamber of the pressure intensifier is connected to a high pressure chamber of the pressure intensifier by means of a check valve, via which the high pressure chamber can be filled. Such a filling of the high pressure chamber is required with each injection cycle so that fluid is available for the high pressure injection. A check valve prevents the high pressure in the high pressure chamber of the pressure intensifier from escaping into the working pressure chamber of the pressure intensifier; however, the check valve does permit the high pressure chamber to be filled from the working pressure chamber.

Advantageously, in addition to the check valve, a throttle is provided, which is connected in series with the check valve. As a result of this measure being taken, in the event of an undesirable increased leakage flow in the injector, e.g. due to a needle jam, a pressure difference is produced between the working pressure chamber and the high pressure chamber.

Preferably, a working pressure chamber of the pressure intensifier is connected to a return chamber of the pressure intensifier by means of a check valve via which the return chamber can be pressure-relieved. As a result, the pressure intensifier piston assumes its maximal stroke when there is a pressure difference between the working pressure chamber and the high pressure chamber and in this position, closes the connection line to the injector. In this manner, the corresponding injector is switched off if it becomes damaged.

It is also particularly advantageous if a return chamber of the pressure intensifier can be filled from the working pressure chamber. For example, this can take place by means of a throttle. An abrupt increase of the pressure in the return chamber is not permitted because of the throttle. However, it is possible to fill the return chamber by means of the throttle so that the pressure intensifier is ready for the next injection operation.

It can be advantageous if the actuating element is disposed between the pressure intensifier and the valve device. In this manner, for example, the first 2/2-port directional-control valve can be shifted into the vicinity of the injector, which prevents a needless enlargement of the control chamber.

However, it can also be useful if the actuating element is disposed between the first 2/2-port directional-control valve and the second 2/2-port directional-control valve. In particular, the actuating element can be disposed so that its movement runs perpendicular to the longitudinal expansion of the injection device. This also has advantages with regard to minimizing the volume of the control chamber for the stroke control and also of the pressure intensifier.

It can also be advantageous if the actuating element is disposed above the valve device and the pressure intensifier. This variant offers the possibility of a very compact design.

Preferably, the actuating element is a piezoelectric actuator. Piezoelectric actuators have proven successful as electronically activated actuating elements, particularly since they are compact in design and reliable in function. Furthermore, the actuating function can be changed by altering the parameters (voltage, pulse duration) of the activation.

However, it can also be useful to embody the actuating element and the valve device by means of a solenoid valve with two valve bodies, in which a first valve body with a valve sealing seat and a second valve body with a valve sealing seat are disposed coaxially inside each other. In this case, the first valve body is advantageously connected to the actuating element by means of a connecting member disposed inside the second valve body. It is particularly preferable that the guide of the first valve body be disposed outside the second valve body. The invention is therefore not limited to the use of a piezoelectric actuator. Rather, it is also possible to produce a compact and reliable variant based on the above-mentioned embodiments with a solenoid valve.

The invention is based on the method according to preamble to claim 16 in that a first 2/2-port directional-control valve and a second 2/2-port directional-control valve of the valve device are actuated by the actuating element. Only a single actuating element and its preferably electronic activation are required in order to actuate both the first 2/2-port directional-control valve and the second 2/2-port directional-control valve.

It is particularly preferable that the first 2/2-port directional-control valve and the second 2/2-port directional-control valve be actuated by the actuating element by means of a shared hydraulic coupling chamber. Therefore a reduction in apparatus expense can also be achieved at this point; the method according to the invention can be embodied in a simple fashion.

Preferably, the opening of the first 2/2-port directional-control valve produces an injection at a low pressure and the opening of the second 2/2-port directional-control valve produces an injection at a higher pressure. This permits the advantages of the respective injections to be combined, which is particularly useful in connection with the use of the invention in a common rail system.

Preferably, the actuation of the first 2/2-port directional-control valve is used for the preinjection. Consequently, an injection can be executed at a low pressure and with a small injection quantity.

It is particularly useful if the opening of one of the 2/2-port directional-control valves is produced by means of a smaller stroke of the actuating element than the opening of the other of the 2/2-port directional-control valves. In particular, with a piezoelectric actuator, the variation of the stroke can be achieved by means of the input variables of the electronic triggering (voltage, pulse duration).

In a particularly preferred embodiment of the method according to the invention, a first valve is opened through partial actuation of the actuating member, whereupon a preinjection begins at a low pressure, and then the restoring of the actuating element closes the first valve so that the injection is terminated. With the invention, it is therefore possible to execute a preinjection independently of possible other operations during the injection sequence.

The method according to the invention is particularly advantageous because a control chamber is pressure-relieved through partial actuation of the actuating element so that the injector opens and an injection phase at a low pressure begins, whereupon through further actuation of the actuating element, a return chamber of the pressure intensifier is connected to a return system through the opening of the second 2/2-port directional-control valve, after which a pressure increase of the injection pressure is produced by the pressure intensifier so that now, an injection phase occurs at a high pressure and then, through the restoring of the actuating element, the first 2/2-port directional-control valve and the second 2/2-port directional-control valve close so that the injection is terminated. It is consequently possible to produce a favorable sequence of preinjection and main injection as well as a “boat”-shaped main injection by virtue of the fact that a single actuating element communicates with two 2/2-port directional-control valves, preferably by means of a single coupling chamber. The advantages of a stroke-controlled preinjection are combined with the advantages of an increasing march of pressure during the main injection. It can also be useful that, through actuation of the actuating element, a return chamber of the pressure intensifier is connected to a return system through the opening of the second 2/2-port directional-control valve and a pressure increase is produced by the pressure intensifier and that through further actuation of the actuating element, a control chamber is pressure-relieved so that the injector opens, starting an injection phase at a high pressure. In these variants, a secondary injection at a high pressure level can occur in an advantageous manner: by switching from the second switched position back into the first switched position, only the injector is closed; the pressure intensifier remains active. A new switch back into the second switched position then opens the injector for a secondary injection at a high pressure.

Preferably, the high-pressure chamber of the pressure intensifier is filled by means of a check valve via which it is connected to the working pressure chamber. Since there is a sufficient fluid reservoir in the working pressure chamber, it is useful to use this to fill the high-pressure chamber by means of a check valve. On the other hand, the high pressure from the high-pressure chamber cannot travel through the check valve into the working pressure chamber of the pressure intensifier; the pressure is used entirely for triggering the injector.

Preferably, a return chamber of the pressure intensifier is filled from the working pressure chamber of the pressure intensifier. This can take place, for example, by means of a throttle. A throttle consequently permits the pressure intensifier to be filled and readied for the next injection operation; however, it prevents an undesirable transmission of a rapid pressure change from the working pressure chamber of the pressure intensifier into the return chamber.

The method is particularly advantageous when a shaping of the injection sequence is executed through the chronological triggering sequence of the actuating element and/or through the design of the valve switching forces. The system consequently offers numerous possible variations, which can be installed in a fixed manner through the design of the components or can be changed during the process through the triggering of the actuating element.

The invention is distinguished in particular in that an injection device with a pressure intensifier can be reliably controlled through the use of two 2/2-port directional-control valves, which are actuated by a shared actuating element by means of a shared coupling chamber. It is therefore no longer necessary to provide separate electronic and hydraulic triggering for the pressure intensifier and injector. This yields an advantageous reduction in the apparatus expense. In a preferred embodiment of the invention, the advantages of a stroke-controlled preinjection can be advantageously combined with the advantages of an increasing march of pressure during the main injection.

### DRAWINGS

The invention will now be explained by way of example with reference to the drawings and in conjunction with particular embodiments.

FIG. 1 shows a first embodiment of an injection device according to the invention;

FIG. 2 shows a second embodiment of an injection device according to the invention;

FIG. 3 shows a third embodiment of an injection device according to the invention;

FIG. 4 shows a hydraulic connection diagram with important system components;

FIG. 5 shows a fourth embodiment of an injection device according to the invention.

### DESCRIPTION OF THE EXEMPLARY EMBODIMENTS

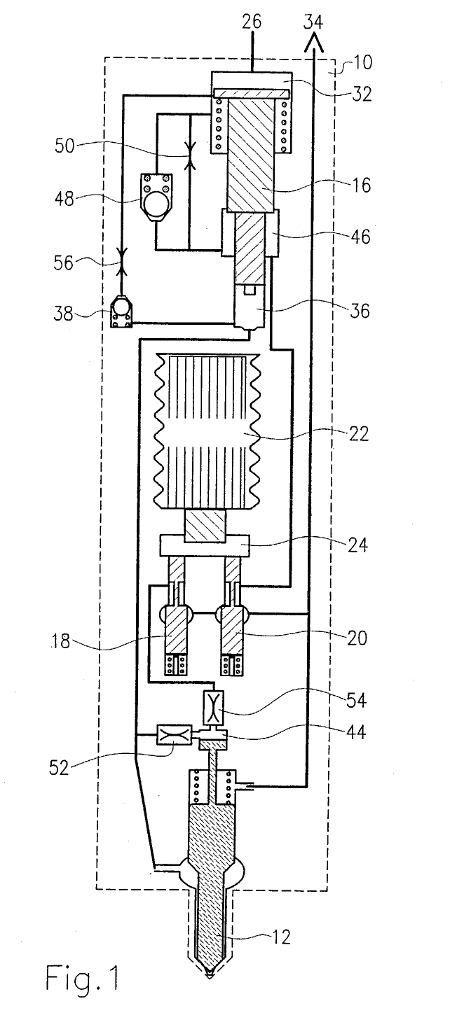

FIG. 1 shows a first embodiment of an injection device 10 according to the invention. An injector 12 serves to inject fuel into the combustion chamber of a motor, in particular a diesel motor. The injector 12 is supplied with fuel at a pressure from a pressure intensifier 16. The injector 12 is triggered by a first 2/2-port directional-control valve 18. The pressure intensifier 16 is controlled by a second 2/2-port directional-control valve 20. Both of the 2/2-port directional-control valves 18, 20 are operated by a piezoelectric actuator 22 by means of a shared hydraulic coupling chamber 24. When the first 2/2-port directional-control valve 18 is closed, a pressure builds up in a control chamber 44, which in the normal case corresponds to the pressure of a pressure reservoir (common rail) 26; this provides the primary pressure for the injection device 1. The pressure in the control chamber 44 exerts a closing force on the injector 12, which closes the injector. Through the opening of the first 2/2-port directional-control valve 18, the control chamber 44 is pressure-relieved, the closing force decreases, and the injector 12 can open as a result of this stroke control. When closed, the second 2/2-port directional-control valve 20 closes a connection between the return system 34 of the injection device and a return chamber 46 of the pressure intensifier 16. When the second 2/2-port directional-control valve 20 opens, then the pressure chamber 46 can be pressure-relieved, consequently permitting a pressure invitation by means of the pressure intensifier 16. The working pressure chamber 32 and the high-pressure chamber 36 of the pressure intensifier 16 are connected to each other by means of a check valve 38 and a throttle 56.

Consequently, the high-pressure 36 can be refilled from the working pressure chamber 32 by way of the check valve 38 in order to prepare for the next pressure intensification, while the throttle 56 prevents the filling path from functioning as a bypass during an injection. An addition check valve 48 is provided by means of which the working pressure chamber 32 is connected to the return chamber 46 of the pressure intensifier 16. The check valve 48 prevents the buildup of an overpressure in the return chamber 46 of the pressure intensifier. A throttle 50 connected in parallel to the check valve 48 permits the return chamber 46 to be refilled, but prevents an undesirable abrupt transmission of pressure between the working pressure chamber 32 and the return chamber 46. In order to establish the opening speed of the nozzle needle of the injector 12, two additional throttles 52, 54 are provided as an inlet throttle 52 and an outlet throttle 54 of the control chamber 44. It should be noted that in particular, the check valve 48 and the throttle 56 do in fact confer considerable advantages with regard to the inherent safety of the system, but do not have to be fundamentally decisive for the operational capability of the system.

For example, the injection device 10 can be operated in such a way that the piezoelectric actuator 22 is at first activated in such a way that only a small stroke (partial stroke) is executed. This stroke is selected so that the first 2/2-port directional-control valve 18 opens, but the second 2/2-port directional-control valve 20 remains closed. Through the opening of the first 2/2-port directional-control valve 18, the control chamber 44 is pressure-relieved by means of the throttle 54 and a stroke-controlled opening of the injector 12 takes place. At this point, normally the pressure of the common rail 26 prevails in the injector 12 by means of the working pressure chamber 32 of the pressure intensifier 16, the throttle 56, and the check valve 38. An injection is executed at a low injection pressure. Then, a greater stroke of the piezoelectric actuator 22 is executed so that the second 2/2-port directional-control valve 20 also opens. This results in a pressure-relief of the return chamber 46 of the pressure intensifier 16 since this chamber is connected to the return system 34 by means of the second 2/2-port directional-control valve 20. This results in a pressure intensification by means of the pressure intensifier 16. This is followed by an increase in the injection pressure and consequently an injection phase at a high injection pressure. Upon deactivation of the piezoelectric actuator 22, the 2/2-port directional-control valves 18, 20 return to their initial position—first the second 2/2-port directional-control valve 20 and then the first 2/2-port directional-control valve 18. With a partial deactivation down to a partial stroke, only the second valve returns to its initial position. The pressure intensifier 16 is refilled. To be reset, the return chamber 46 of the pressure intensifier 16 is refilled with fluid from the working pressure chamber 26 of the pressure intensifier 16, for example by means of the throttle 50. The high-pressure chamber 36 of the pressure intensifier 16 is filled from the working pressure chamber 32 of the pressure intensifier 16 by means of the throttle 56 and the check valve 38. The triggering of the first 2/2-port directional-control valve 18 with a small stroke of the piezoelectric actuator 22 can therefore be advantageously used to execute a low-pressure preinjection.

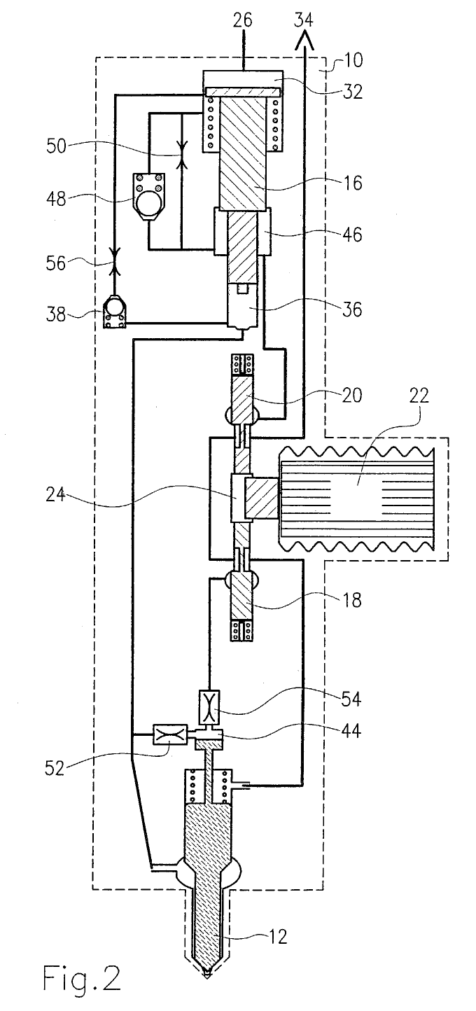

In FIG. 2, the piezoelectric actuator 22 is situated on the side of the injection device 10. It is therefore possible for the first 2/2-port directional-control valve 18 and the second 2/2-port directional-control valve 20 to be disposed in a 180° arrangement. Such an arrangement has advantages with regard to minimizing the volume of the effective control chamber for the stroke control as well as the volume of the pressure intensifier 16. Components that correspond to those in FIG. 1 have been provided with the same reference numerals.

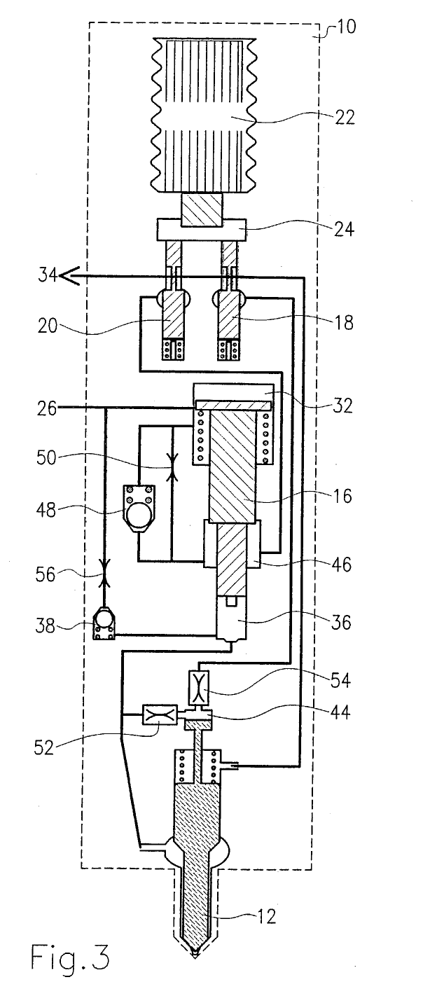

FIG. 3 shows another arrangement of the components of the injection device. In this instance, the piezoelectric actuator 22 is disposed above the pressure intensifier 16, which produces a very compact design. Once again, components that correspond to those in FIGS. 1 and 2 have been provided with the same reference numerals.

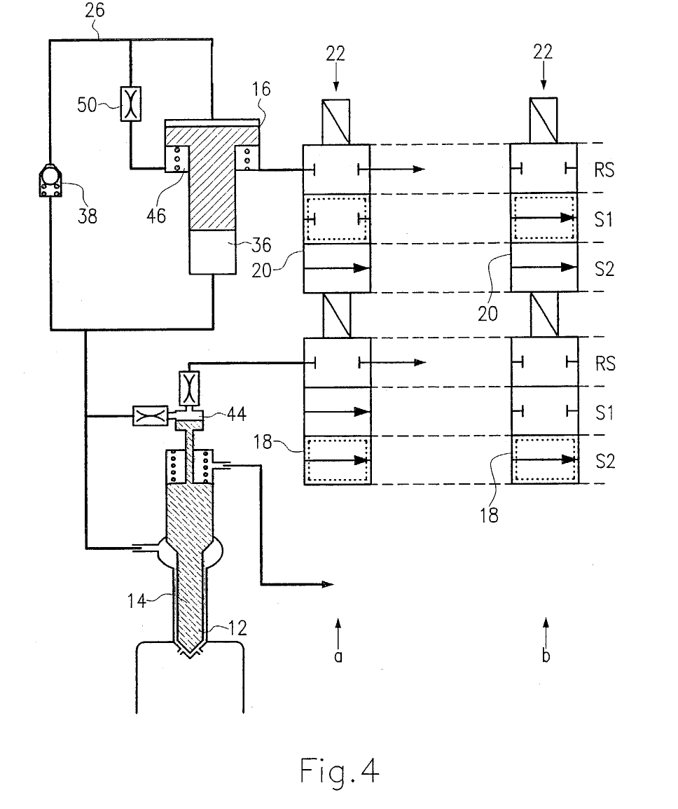

FIG. 4 shows a hydraulic connection diagram. For example, a quantity-controlled high-pressure pump is used to generate the system pressure. The fuel is compressed to a controllable first system pressure of approx. 300 bar to approx. 1500 bar and is stored in a pressure reservoir (common rail) 26. The injection is controlled through needle stroke control over the valve 18, which is schematically represented in its different switching states. In addition, a pressure intensifier 16 for increasing the injection pressure is disposed between the common rail 26 and the injector 14. The pressure intensifier 16 is triggered by a 2/2-port directional-control valve 20, which is likewise schematically depicted in its different switching states. A bypass with a check valve 38 is available for the refilling of the high-pressure chamber 36 of the pressure intensifier 16.

In principle, the arrangement shown can be used to produce injections with different pressures. If the valve 20 is closed, then the entire injector 14 is under rail pressure; the pressure intensifier 16 is in its initial position. Through the triggering (stroke control) of the injector 12 with the valve 18, an injection with rail pressure can be executed in the same way as in a common rail system of the prior art. If an injection with an increased injection pressure is to take place, then the valve 20 is triggered. Consequently, the pressure intensifier 16 is actuated.

What is special about the arrangement according to the invention is that both of the valves 18, 20 are triggered with the same actuator 22. The actuator 22 has three positions—a neutral position and two switched positions. Varying the triggering of the actuator 22 causes it to assume the different positions.

The left side (a) of the schematic valve depiction in FIG. 4 shows a process sequence, which permits a “boat injection”.

In the neutral position (RS) both of the valves 18, 20 have no through flow. The rail pressure prevails in the injector 14 by means of the bypass path with the check valve 38. The injector 12 is closed due to the pressure in the control chamber 44. The pressure intensifier 16 is disposed in its initial position.

If the actuator 22 is brought into the first switched position (S1), then the valve 18 switches, which triggers the injector 14 into a through flow position. The valve 20, which triggers the pressure intensifier 16, remains closed. As a result, an injection at rail pressure is initiated. In this case, only the control chamber 44 of the injector has to be triggered and a small valve stroke suffices. It is therefore possible to execute an injection with a rapid switching time so that the process described here can advantageously be used for a preinjection.

In the second switched position (S2) of the actuator 22, both of the valves 18, 22 are switched into a through flow position. Consequently, both control chamber 44 of the injector 14 and also the return chamber 46 of the pressure intensifier 16 are pressure-relieved. As a result, the rail pressure is intensified by the pressure intensifier and an injection occurs at an increased injection pressure.

If the system according to a variant (a) in FIG. 4 is first brought into the first switched position (S1) and is then switched into the second switched position (S2) after a certain delay, this produces a boat injection.

Another embodiment of the invention is shown on the right side (b) in FIG. 4.

The neutral position (RS) corresponds to the one in the exemplary embodiments shown on the left side (a).

In the first switched position (S1), the valve 20, which triggers the pressure intensifier 16, is switched into a through flow position. This activates the pressure intensifier 16.

In the second switched position (S2), both of the valves 18, 20 are opened so that the injector 14 is also triggered.

In this variant (b), a secondary injection at a high pressure can be advantageously executed: by switching from the second switched position (S2) back into the first switched position (S1), only the injector 12 is closed; the pressure intensifier 16 remains active. A renewed switch back into the second switched position (S2) then opens the injector 12 for a secondary injection at a high pressure.

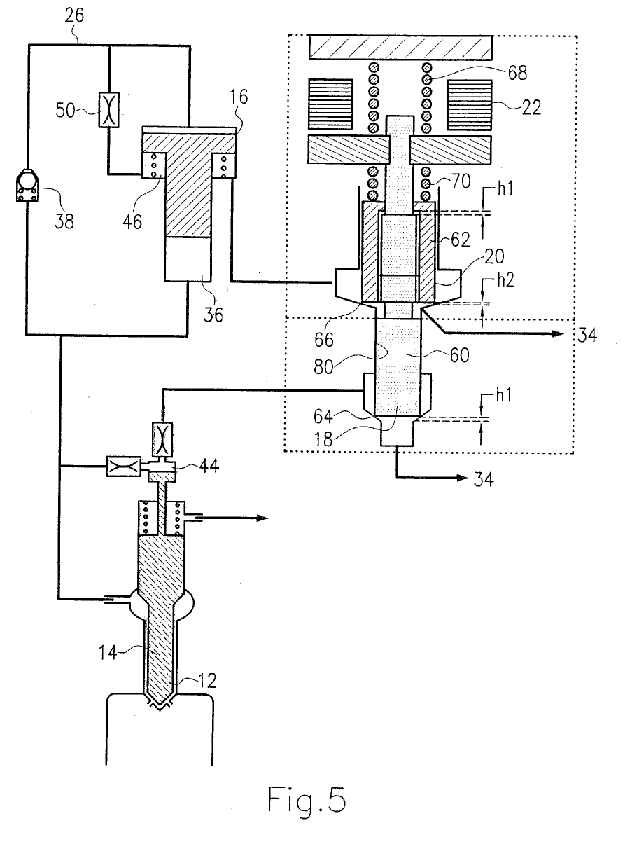

FIG. 5 shows an embodiment of the invention. A three-stage magnetic actuator is provided as the actuator 22. The valves 18, 20 are situated coaxially.

In the first switched position, which the device assumes when triggered with a low switch voltage, only the small stroke (h1) is executed, until the first valve body 60 strikes against the second valve body 62. In this connection, only the first valve body 60 moves, producing a through flow at the valve seat 64 of the valve 18. The second valve body 62 remains against its valve seat 66 so that the valve 20 remains closed. In this phase, the springs 68, 70 of the actuator 22 work in opposition, resulting in a reduced spring force. This low effective spring force, the low mass being moved (only the first valve body 60 moves), and the small stroke permit a rapid switching time to be achieved. This is particularly advantageous for a preinjection. The device assumes the second switched position when the actuator 22 is triggered with a higher control voltage. As a result, the stroke (h2) is also executed and the valve seat 66 of the valve 20 also switches to a through flow position. The guide 80 of the first valve body 60 is situated outside the second valve body 62.

It can be particularly advantageous for the invention that the valve body 60 is permitted to have a certain amount of play in relation to the valve body 62. This permits a two-part and therefore simpler production of the double valve representing the valves 18, 20.

The foregoing description of the exemplary embodiments according to the current invention is intended only for illustrative purposes and not for the purpose of limiting the invention. The invention includes the possibility of various changes and modifications without going beyond the scope of the invention and its equivalents.

1. An injection device with an injector (12), a pressure intensifier (16) for intensifying a primary pressure, a valve device (18, 20) for actuating the pressure intensifier (16), and an actuating element (22) for actuating the valve device (18, 20), characterized in that the valve device has at least one first 2/2-port directional-control valve (18) and one second 2/2-port directional-control valve (20), which can be actuated by the actuating element (22).

2. The injection device according to claim 1, characterized in that the first 2/2-port directional-control valve (18) and the second 2/2-port directional-control valve (20) can be actuated by the actuating element (22) by means of a shared hydraulic coupling chamber (24).

3. The injection device according to claim 1 or 2, characterized in that the primary pressure is supplied from a common rail (26).

4. The injection device according to one of the preceding claims, characterized in that it is stroke-controlled.

5. The injection device according to one of preceding claims, characterized in that in a first state, the first 2/2-port directional-control valve (18) uncouples a control chamber (44) for a stroke control from a return system (34) and that in a second state, the first 2/2-port directional-control valve (18) couples the control chamber (44) for the stroke control to the return system (34).

6. The injection device according to one of preceding claims, characterized in that in a first state, the second 2/2-port directional-control valve (20) closes a return chamber (46) of the pressure intensifier (16) off from a return system (34) and that in a second state, the second 2/2-port directional-control valve (20) couples the return chamber (46) of the pressure intensifier (16) to the return system (34).

7. The injection device according to one of preceding claims, characterized in that the two 2/2-port directional-control valves (18, 20) are matched to each other so that through partial actuation of the actuating element (22), one 2/2-port directional-control valve (18, 20) can be switched from its first state into its second state and then, through further actuation of the actuating element (22), the other 2/2-port directional-control valve (18, 20) can be switched from its first state into its second state.

8. The injection device according to one of claims 4 to 7, characterized in that a control chamber (44) for the stroke control is connected to the first 2/2-port directional-control valve (18) via a first throttle (54) and that the control chamber (44) for the stroke control is connected to the inlet region of the injector (12) via a second throttle (52).

9. The injection device according to one of preceding claims, characterized in that a working pressure chamber (32) of the pressure intensifier (16) communicates with a high pressure chamber (36) of the pressure intensifier (16) by means of a check valve (38) via which the high pressure chamber (36) can be filled.

10. The injection device according to one of preceding claims, characterized in that the inlet region of the injector (12) is connected to a pressure reservoir (26) by means of a check valve (38).

11. The injection device according to one of preceding claims, characterized in that a return chamber (46) of the pressure intensifier (16) can be filled from the working pressure chamber (32)

12. The injection device according to one of preceding claims, characterized in that the actuating element is a piezoelectric actuator (22).

13. The injection device according to one of claims 1 to 11, characterized in that the actuating element and the valve device are embodied by means of a solenoid valve with two valve bodies (60, 62), in which a first valve body (60) with a valve sealing seat (64) and a second valve body (62) with a valve sealing seat (66) are disposed coaxially inside each other.

14. The injection device according to claim 13, characterized in that the first valve body (60) is connected to the actuating element by means of a connecting member, which is disposed inside the second valve body (62).

15. The injection device according to claim 13 or 14, characterized in that the guide (80) of the first valve body (60) is disposed outside the second valve body.

16. A method for injecting fluid, in which an actuating element (22) is activated, the actuating element (22) actuates a valve device (18, 20), the valve device (18, 20) actuates a pressure intensifier (16) for intensifying a primary pressure, and an injector (12) is opened, characterized in that the actuating element (22) actuates a first 2/2-port directional-control valve (18) and a second 2/2-port directional-control valve (20) of the valve device (18, 20).

17. The method according to claim 16, characterized in that the first 2/2-port directional-control valve (18) and the second 2/2-port directional-control valve (20) are actuated by the actuating element (22) by means of a shared hydraulic coupling chamber (24).

18. The method according to claim 16 or 17, characterized in that the opening of the first 2/2-port directional-control valve (18) produces an injection and that the opening of the second 2/2-port directional-control valve (20) produces a pressure increase.

19. The method according to claim 16 to 18, characterized in that the actuation of the first 2/2-port directional-control valve (18) is used for the preinjection.

20. The method according to one of claims 16 to 19, characterized in that the opening of one of the 2/2-port directional-control valves (18, 20) is produced by a smaller stroke of the actuating element (22) than the opening of the other of the 2/2-port directional-control valves (18, 20).

21. The method according to one of claims 16 to 20, characterized in that the actuation of the actuating element (22) causes a control chamber (44) to be pressure-relieved so that the injector (12) opens and an injection phase at a low pressure is initiated, whereupon through further actuation of the actuating element (22), a return chamber (46) of the pressure intensifier (16) is connected to a return system (34) through the opening of the second 2/2-port directional-control valve (20), whereupon the pressure intensifier (16) produces a pressure intensification so that an injection phase at a high pressure takes place and then, through the resetting of the actuating element (22), the first 2/2-port directional-control valve (18) and the second 2/2-port directional-control valve (20) close so that the injection is terminated.

22. The method according to one of claims 16 to 20, characterized in that through actuation of the actuating element (22), a return chamber (46) of the pressure intensifier (16) is connected to a return system (34) through the opening of the second 2/2-port directional-control valve (20) and the pressure intensifier (16) produces a pressure intensification and that through further actuation of the actuating element (22), a control chamber (44) is pressure-relieved so that the injector (12) opens and an injection phase at a high pressure produced.

23. The method according to one of claims 16 to 22, characterized in that a high pressure chamber (36) of the pressure intensifier (16) is filled by means of a check valve (38) via which it is connected to a working pressure chamber (32) of the pressure intensifier (16).

24. The method according to one of claims 16 to 23, characterized in that the pressure chamber (46) of the pressure intensifier (16) is filled from the working pressure chamber (32) of the pressure intensifier (16).

25. The method according to one of claims 16 to 24, characterized in that a shaping of the injection sequence is executed through the chronological triggering sequence of the actuating element (22) and/or through the design of the valve switching forces.
